(19) United States
(12) Patent Application Publication
(10) Pub. No.: US 2026/0103303 A1
(43) Pub. Date: Apr. 16, 2026

(54) METHOD FOR WIND HARVESTING AND WIND REJECTION IN FLYING DRONES

(71) Applicant: ECOLE POLYTECHNIQUE FEDERALE DE LAUSANNE (EPFL), Lausanne (CH)

(72) Inventors: Charalampos VOURTSIS, Lausanne (CH); Dario FLOREANO, Lausanne (CH); Nathan Samuel MÜLLER, Morges (CH); William John STEWART, Cary, NC (US); Victor Casas ROCHEL, Mies (CH)

(21) Appl. No.: 19/116,130

(22) PCT Filed: Sep. 28, 2022
(86) PCT No.: PCT/IB2022/059235

§ 371 Date: Mar. 27, 2025

(51) Int. Cl. B64U 40/20; B64U 10/20; B64U 30/12

(52) U.S. Cl. CPC B64U 40/20; B64U 10/20; B64U 30/12

(57) ABSTRACT

The present invention concerns a method of manoeuvring a vertical take-off and landing, unmanned aerial drone (100) comprising at least an aerodynamic surface (101), wherein, during a flight of the drone, the aerodynamic surface generates lift and/or drag and an aerodynamic surface area is dynamically varied to compensate for adverse wind currents and/or to use said wind currents and/or to use an effective airspeed velocity as an assistance in manoeuvring the drone flight, said aerodynamic surface area variations allowing to reduce an energy consumption of the drone.

### TECHNICAL FIELD

The present invention concerns the field of drones. More specifically, the present invention concerns vertical take-off and landing drones (“VTOLs”) with wings and the method used to operate and fly such drones.

BACKGROUND ART Hybrid Unmanned Aerial Vehicles (UAVs) refer to drones that combine the benefits of fixed-wing and rotary-wing aircraft in that they are capable of both horizontal and vertical (hovering) flight operations, see reference [1].

Most hybrid UAVs reorient the entire propulsion system or use a dedicated propulsion unit for each flight mode, see references [2, 1]. The reorientation of the propulsion system or the presence of additional propulsion units increases the mechanical complexity and weight of these UAVs, resulting in reduced energy efficiency.

Tail-sitters are a type of hybrid UAV with fixed wings capable of hovering and transitioning to horizontal flight without reorienting the propulsion system or the dedicated propulsion units. The tail-sitter design has the lowest mechanical complexity, but the exposed wings leave the vehicle particularly prone to crosswinds in hovering flight, see reference [2].

In nature, flying animals like birds and insects operate in diverse wind conditions by adapting their wing morphology or body configuration according to the flight performance they need to achieve, see reference [3]. Birds change the shape of their wings to increase or decrease their agility, and insects rapidly change their flapping angles to perform highly agile manoeuvres, see references [4, 5, 6]. Wing morphing is a commonly adopted strategy by engineers, although current vehicles fail to achieve the performance of natural flyers, see reference [7] Nevertheless, different approaches have already been proposed as solutions for gust rejection and increased manoeuvrability in the hovering regime of VTOL platforms. Sweeping wings are retracted during hovering to reduce the moment of inertia, thus increasing manoeuvrability, see references [8, 9].

However, in the work of Kevin (see reference [0009]), the area of the wings remains unchanged throughout the flight, and therefore, the vehicle's performance in crosswinds does not change. In contrast, in the work of Heredia (see reference [8]), the wings are entirely retracted in hovering, thus not providing any possible aerodynamic benefit as it would be in the cases where the drone is flying with the wind. Another solution for wind rejection is to adapt the wing design to enforce flow detachment in the airfoil's leading edge to mitigate turbulent perturbations. However, this solution would not be applicable in wings oriented perpendicular to crosswinds where the wings are in deep stall, and the drag effects are predominant to the lift generation, see reference [10]. Furthermore, biologically inspired morphing wings attract interest to make winged drones more agile in wind conditions, but these do not specifically address the problem of withstanding adverse winds or hovering flight, see references [10, 11, 12].

Other topics of work that focus explicitly on mitigating wind effects concentrate on controller development, although they do not address wind energy harvesting, see references [13, 14, 15].

Rather than simply reducing the adverse wind effects, other studies show the possibility of harvesting energy to increase range and endurance by exploiting thermal wind currents. This approach is widely investigated for powered and unpowered fixed-wing soaring, see references [16, 17, 18, 19]. However, this particular strategy requires the aircraft to continuously pass through air masses with different speeds and at specific angles of attack, which is not the primary mode of operation profile of VTOL platform in hovering, where it is required to fly for long periods at angles of attack of more than 60°.

Consequently, intense winds are a challenge for vertical take-off and landing drones (VTOLs) with wings. In particular, in the hovering regime, wings are sensitive to wind currents that can be detrimental to their operational and energetic performances. Tail-sitter drones are particularly prone to those wind currents because their wings are perpendicular to the incoming wind during hovering. This wind generates a large amount of drag and can displace and destabilize the vehicle, possibly leading to catastrophic failures.

### SUMMARY OF THE INVENTION

An aim of the present invention is to improve the known devices and methods. Another aim of the present invention to improve the known drones and flying control methods of such drones.

More specifically, it is an aim of the present invention to improve VTOL drones with wings, for example tail-sitter drones.

A further aim of the present invention is to provide control methods of such drones.

A further aim of the present invention is to provide a VTOL device, such as a drone, that is able to increase its flying stability, especially in a hovering regime.

Further aims and goals will be apparent from the following description of the invention.

In order to achieve these aims and goals, in the present application is described a strategy utilizing the morphing wings of a VTOL platform in such a way to increase stability against adverse winds while leveraging wind energy for efficient hovering flight and increased manoeuvrability in the yaw axis (FIG. 1 (A)).

More specifically, to achieve these aims and goals, the present application discloses embodiments of a morphing strategy demonstrated in a custom-built 1.8 kg tail-sitter with morphing wings that can actively resist winds and leverage them to increase its aerodynamic efficiency.

The present application and the embodiments disclosed herein show that adaptive wing morphing during hovering in adverse wind conditions can reduce normalized energy consumption up to 85%, increase attitude and positional stability, and leverage wind energy to increase its yaw angular rate up to 200% while decreasing motor saturation levels

The morphing mechanism of the aerodynamic surface according to the invention, that is the means used to change the aerodynamic surface area, may comprise one or more objects or components interconnected or not to each other and/or placed or not in contact and/or proximity to the aerodynamic surface and/or the fuselage of the aircraft (the drone). The objects or components may morph in sync or independently different parts of the (aerodynamic surface) wing/wings.

In the invention, the objects or components may act dependently or independently to change the shape of the aerodynamic surface.

In the invention, the objects or components may be active or passive actuation systems that enable the change of the aerodynamic surface's area. Typically, as non-limiting examples, active actuation uses a motor, such as a linear actuator, servomotor, dc motor etc.) whereas a passive actuation uses a compliant or bistable component or mechanism, such as a spring, an elastic joint, a bistable joint etc.

The method according to the invention may be adapted to work in different ranges of hovering speed.

The method according to the invention may be adapted to different vehicle scales with different variations.

The method according to the invention may be applied to continuous or non-continuous aerodynamic surfaces.

The method according to the invention may be applied regardless of the wind direction on the drone. The wind could be perpendicular or not to the ground and or come from different angles on a 3-dimensional reference frame. The method of the present invention may be applied regardless of the orientation of the vehicle with respect to the resultant wind.

The morphing mechanism/strategy according to the invention may adapt the aerodynamic surface area in a linear and/or nonlinear way.

The morphing of the aerodynamic surfaces according to the invention may or may not change the center of gravity or the aerodynamic center of the drone. This can be exploited to increase maneuverability and agility in flight, for example, turn faster.

The combination of these effects may also contribute to the application and/or effectiveness of attitude control of the drone.

Embodiments of the invention are defined by the appended claims of the present application.

In embodiments, the present invention concerns a method of manoeuvring of flying a vertical take-off and landing, unmanned aerial drone (for example a hybrid drone but not limited to such a drone) comprising at least an aerodynamic surface, wherein, during flight, the aerodynamic surface generates lift and/or drag and an aerodynamic surface area is dynamically varied to compensate for adverse wind currents and/or to use said wind currents and/or to use an effective airspeed velocity as an assistance in manoeuvring the drone flight, said aerodynamic surface area variations allowing to reduce an energy consumption of the drone.

In embodiments, the aerodynamic surface area variations may be carried out during hovering of the drone.

In embodiments, the aerodynamic surface area may be varied dynamically, continuously, symmetrically or asymmetrically between a minimum and maximum surface area configuration.

In embodiments, the aerodynamic surface area may be varied asymmetrically by adapting one of said at least an aerodynamic surface area between a minimum and a maximum surface area configuration.

In embodiments, the asymmetrical surface area variations may allow an attitude control of the drone and/or to increase the maximum achievable yaw rate.

In embodiments, the aerodynamic surface may be provided or formed at least by wings of the drone.

In embodiments, the aerodynamic surface area variation may realized at least by a displacement of at least one of said wings.

In embodiments, the aerodynamic surface area may be varied by a rotation of said wings between a retracted position close to the drone and an extended position away from the drone.

In embodiments, the aerodynamic surface area may be varied dynamically and/or statically and/or continuously by an active or passive mechanism.

In embodiments, the aerodynamic surfaces may be continuous or non-continuous.

In embodiments, the aerodynamic surface area may be varied in a linear way and/or a non-linear way.

In embodiments, said method may be adapted to different hovering speeds. For example, depending on the hovering speed, one may change the design/shape of the wings/fuselage or the change (“morphing”) rate of the parts forming the aerodynamic surface, or the speed of the aerodynamic surface.

In embodiments, the present invention concerns a vertical take-off and landing, unmanned aerial drone (for example a hybrid drone but not limited to such a drone) using the method as defined in the present application to fly or manoeuver.

### BRIEF DESCRIPTION OF THE DRAWINGS

FIG. 1 Illustrates
(A) an embodiment of a morphing Vertical Take-Off and Landing (VTOL) tail-sitter drone in front of a Windshape wind generator, see reference [20];
(B) symmetric wing configurations of the morphing VTOL tail-sitter, namely 0° (top left), 30° (top right), 60° (bottom left) and 90° (bottom right).

FIG. 2: illustrates
2A an embodiment of a morphing VTOL tail-sitter drone
2B a change in the center of gravity (CoG) in the z-axis and moments of inertia (Ixx, Iyy, Izz) in symmetric wing morphing;
2C a change in the center of gravity (CoG) in the z-axis and moments of inertia (Ixx, Iyy, Izz) in asymmetric wing morphing.

FIG. 3 illustrates an embodiment of a high-level controller architecture. A P controller is deployed for controlling the wing morphing state when the wings are used for actively stabilizing yaw. The companion computer communicates with the autopilot through MAVROS, which is a ROS bridge for the MAVLink protocol.

FIG. 4 illustrates an aerodynamic experimental setup comprising a drone, a Staubli robotic arm, a WindShape wind tunnel, and an ATI Gamma F/T Sensor. The drone is at 0° angle of attack in this figure as it would be hovering.

FIGS. 5A to 5E show aerodynamic experimental results of the different wing morphing symmetric and asymmetric configurations. Plots display, lift and drag coefficients, the lift to drag ratio and the aerodynamic yaw moment.

FIG. 6 shows the result of an experimental setup
(A) Diagram of wind speed to distance from the wind generator;
(B) Linear trajectory;
(C) Rotational trajectory;
(D) Circular trajectory.

FIG. 7 shows flight experiments with active wing morphing for yaw stabilization and wind disturbance rejection. EW stands for extended wings, RW stands for retracted wings and AW stands for wings that are continuously activated.
(A) Hovering at a setpoint with a fixed orientation,
(B) Hovering in circular trajectory (see FIG. 6(D))

FIG. 8 shows the drifting in linear trajectory (FIG. 6 (B)) at different wind current intensities (%) and the motor saturation levels in different wind speeds while at the extended or retracted configuration. The colored circles (FIGS. 8B and 8D) represent the motor PWM signal and thus the motor saturation. Higher change in color means higher motor saturation. EW is for extended wings and RW is for retracted wings. The drone maneuvers without the motors contribution.
8A The drone maneuvers without the motor contribution.
8B Saturation levels for maneuvering without the motors contribution.
8C The drone maneuvers with the motors contribution.
8D Saturation levels for drone maneuvering with the motors contribution.

FIG. 9 shows the yaw in rotational trajectory (FIG. 6 (C)) at different wind current intensities (%) and the motor saturation levels in different wind speeds while at the wings extended, wings retracted or single wing extended configuration. The colored circles (FIGS. 9B and 9D) represent the motor PWM signal and thus the motor saturation, higher change in color means higher motor saturation. EW is for extended wings, RW is for retracted wings and SW is for a single wing extended.
9A The drone maneuvers without the motor contribution.
9B Saturation levels for maneuvering without the motors contribution.
9C The drone maneuvers with the motors contribution.
9D Saturation levels for drone maneuvering with the motors contribution.

For visualization purposes we plot yaw from 0 to 2 rad.

### DETAILED DESCRIPTION

In the field of drones with wings, the wing area has a strong impact on flight performance. A large wing area increases the vulnerability to cross winds during hovering operations due to large amounts of generated drag. Therefore, VTOLs with fixed wings usually face a design compromise.

There is a trade-off between small wing size for smaller drag during hovering flight and larger wing size for increased lift during horizontal flight. However, this compromise is in fact not perfect as it will impact either the hovering flight performance or the horizontal flight performance: improving one flight performance will have a detrimental effect on the other.

According to the principles and embodiments of the present invention, the above-mentioned compromise need between conflicting conditions is overcome by either symmetrically or asymmetrically changing the drone's area (for example it's wing area) based on the wind direction. In some embodiments, this is accomplished with a wing controller that can adjust the wing area of the drone using simple servo actuators. Other equivalent means to adjust the drone's area (for example the wing's area) are of course possible within the scope of the present invention.

According to embodiments, the present invention is based on minimizing the overall energy consumption and not solely on drag reduction or lift maximization. This means that the controller of the drone is able exploit crosswinds in a beneficial manner depending on if the next commanded waypoint is upwind or downwind of the vehicle. Similarly, in embodiments, the present invention utilizes asymmetric morphing to exploit wind currents for yaw control and/or to increase the drone's maximum achievable yaw rate when used in conjunction with motor actuation. By controlling (or steering) wing asymmetry in windy conditions, yaw control can be decoupled from maintaining altitude or can be assisted by the wing morphing. Indeed, controlling yaw only through deferentially actuated motors exhibits a yaw rate threshold that occurs due to the motors needing simultaneously to maintain altitude and turn the vehicle. Therefore, using wing morphing for yaw control of for an assistance in yaw control is particularly advantageous.

FIG. 1 (A) illustrates a morphing Vertical Take-Off and Landing (VTOL) tail-sitter drone 100 according to an embodiment of the present invention in front of a Windshape wind generator 200 (see reference [20]).

FIG. 1(B) illustrates symmetric wing 101 configurations of the morphing VTOL tail-sitter drone 100 wherein the wings move from a retracted position (“RW”) to a fully extended position (“EW”) with an angular position parameter, namely from 0° (top left), i.e. “RW”, to 30° (top right), to 60° (bottom left) and to 90° (bottom right), i.e. “EW”. For example, in FIG. 1(A), the angle is about 45°.

FIG. 2A illustrates a morphing VTOL tail-sitter drone 100 according to embodiments of the present invention, in its extended “EW” (top drawing) and retracted “RW” (bottom drawing) wings 101 configurations showing a detail in its sweeping wing servo mechanism 103. The drone's weight is for example 1.8 kg. The drone 100 with wings 101 unfolded/extended (“EW”) has a wingspan of 1.45 m and a wing area of 0.44 m², while with the wings retracted (“RW”), it has a wingspan of 0.79 m and a wing area of 0.29 m². The length of the fuselage is 0.62 m. Other dimensions are of course possible in the frame of the present invention and these are only non-limiting examples.

The drone 100 further comprises vertical stabilizers 102, propulsion units 104 (for example with four propellers 104 each with a dedicated motor), and landing gear 105.

As a non-limiting example, the propulsion system may comprise four propellers 104 in tractor mode actuated by four Rctimer 2830 1000 KV brushless motors with a 45 A four-in-one Electronic Speed Controller (ESC). For the wing 101 actuation, two Dynamixel XM430-W350-T servomotors 103 are used. Elevons 109 are only used for attitude control in forward flight. A lithium polymer battery of 2500 mAh in a four-cell configuration powers the drone. The fuselage 106 and the wings 101 are made from cardboard and Expanded Poly Propylene (EPP), a foam material with high mechanical resilience and flexibility. The center of gravity is depicted in both configurations. Carbon beams 107s were used to reinforce the structure and to mount the two servo actuators 103 (Dynamixel XM430-W350-T) used to fold the wing 101 tips. The motor mounts, the servo actuator mounts, and landing gear components were 3D printed with Acrylonitrile Butadiene Styrene (ABS) plastic.

Of course, this is only an example and other equivalent materials, motors, controllers and other parts/sizes may be used in other embodiments of the present invention.

FIG. 2B illustrates the change in the center of gravity (CoG) in the z-axis and moments of inertia (Ixx, Iyy, Izz) in symmetric wing morphing configurations.

FIG. 2C illustrates the change in the center of gravity (CoG) in the z-axis and moments of inertia (Ixx, Iyy, Izz) in asymmetric wing morphing configurations.

The drone 100 according to embodiments of the present invention is a quad tail-sitter UAV with morphing wings 101 that are controlled (i.e. steered) to adapt their surface depending on the flight mode and wind conditions (see FIGS. 1-3): for example, the surface of the wings maybe increased or decreased symmetrically or asymmetrically.

The drone's 100 extended “EW” and retracted “RW” configurations along with the effects of wing morphing in the center of gravity and the moments of inertia are illustrated in FIG. 2(B) and 2(C). For simplicity, each wing 101 has a rectangular airfoil profile with a thickness of approximately 15 mm.

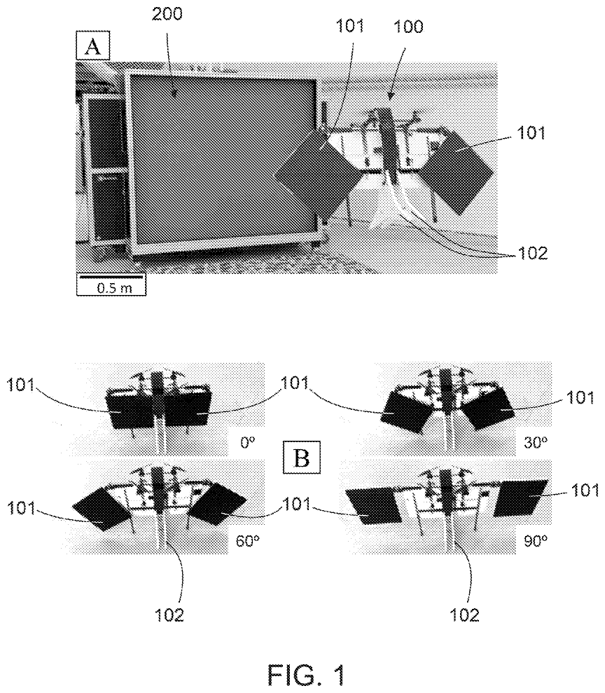

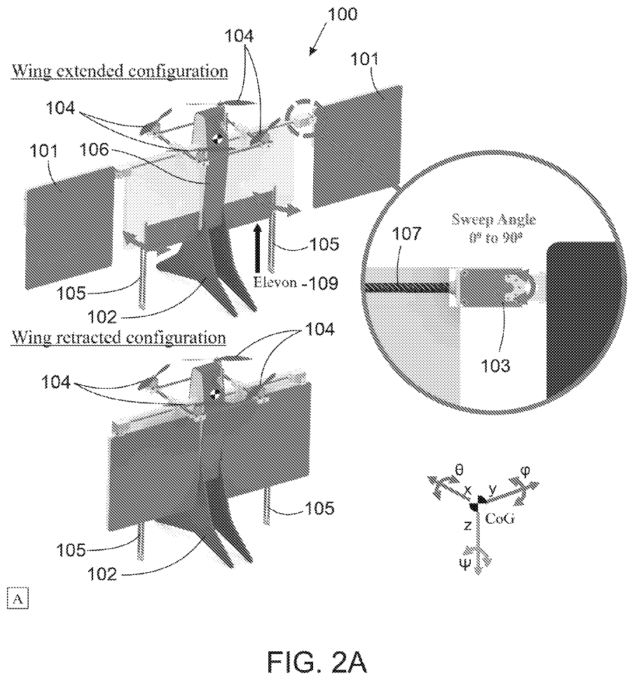

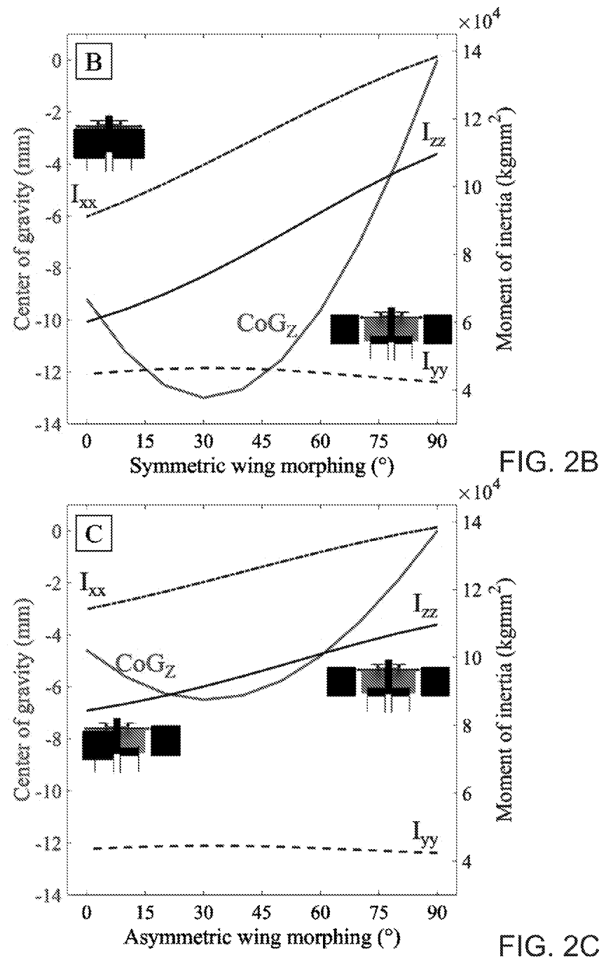

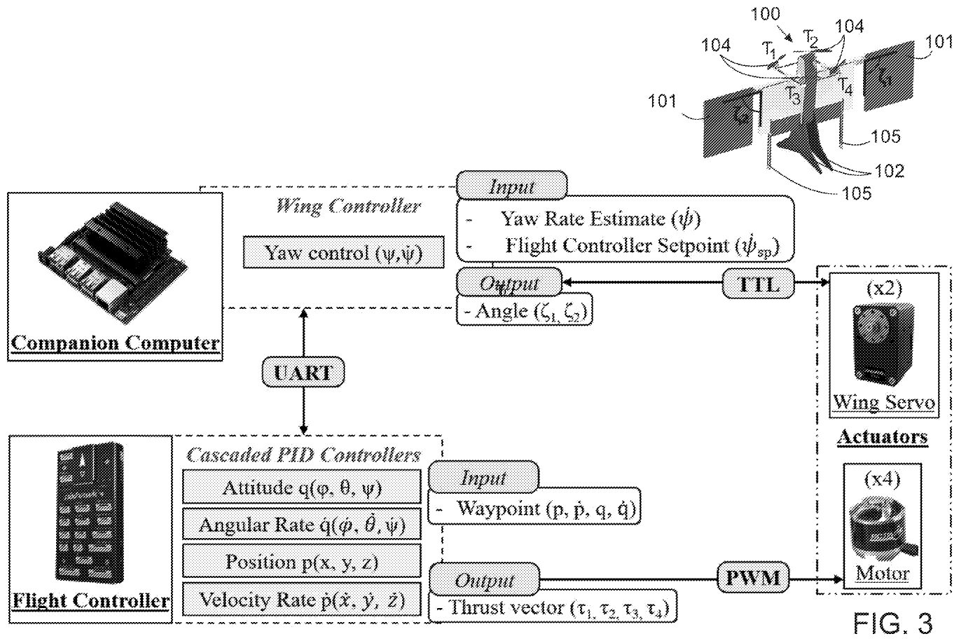

The drone is autonomous during flight (see FIG. 3). For the autonomous flight experiments, a Pixhawk 4 autopilot is utilized in conjunction with a Jetson Nano companion computer on a carrier board modified for weight reduction. The companion computer is required to run the wing controller parallel to the autopilots'function. The companion computer receives information from the autopilot through MAVROS, a ROS bridge for the MAVLink protocol. It uses the state estimation and the trajectory setpoints from the autopilot to adaptively morph the wings. It does so by sending commands to the servo actuators through Dynamixel protocol 2.0 (FIG. 3). All the hardware components are connected serially. The wing servo controller's functionality is generalized and independent from the autopilot as it uses the calculated yaw rate error as input. Therefore, different autopilots could provide the yaw rate setpoint and state estimation.

FIG. 3 illustrates an embodiment of a high-level controller architecture. A P controller is deployed for controlling the wing morphing state when the wings are used for actively stabilizing yaw. The companion computer communicates with the autopilot through MAVROS, which is a ROS bridge for the MAVLink protocol.

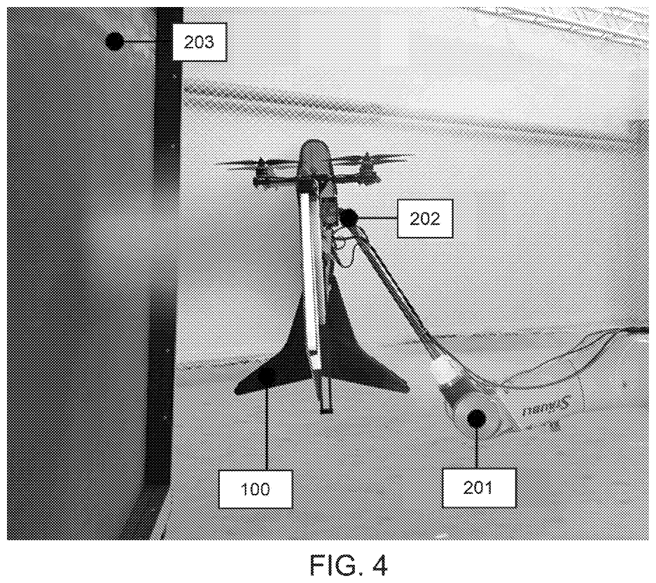

Experiments were performed to investigate the aerodynamic properties of the different wing morphing configurations of the drone according to embodiments of the present invention. A 6 DOF ATI Gamma loadcell was mounted to the bottom part of the drone at its center of gravity (see FIG. 4). Through combinations of different wing morphing states, eight configurations were characterized. These correspond to both symmetric and asymmetric wing morphing configurations for wing sweep angles of 0° to 90° with increments of 30° (see for example FIG. 1(B)). Similar to references [21, 22], the drone 100, was attached to a Staubli robotic arm 201 which was placed in an open-jet WindShape wind tunnel 200, see reference [20]. The robot was programmed to drive the robot arm 201 through a commanded angle of attack. The angle of attack was varied between 40° and −50° starting from 0° and in increments of 4°. The drone 100 was positioned such that the fuselage 106 of the drone is approximately 50 cm from the wind tunnel filter 203. Experiments were run at wind speeds of 1.7 m/s, 3.4 m/s, and 4.6 m/s measured at the beginning of the free stream which corresponds to Reynolds numbers of 35898, 71796, 97135 as calculated with the reference length of the morphing wing when horizontal to the flow. Data samples were recorded at 120 Hz after the wing flow had reached a steady state. Recorded forces were rotated to the wind frame to calculate Lift, Drag, and Yawing Moments.

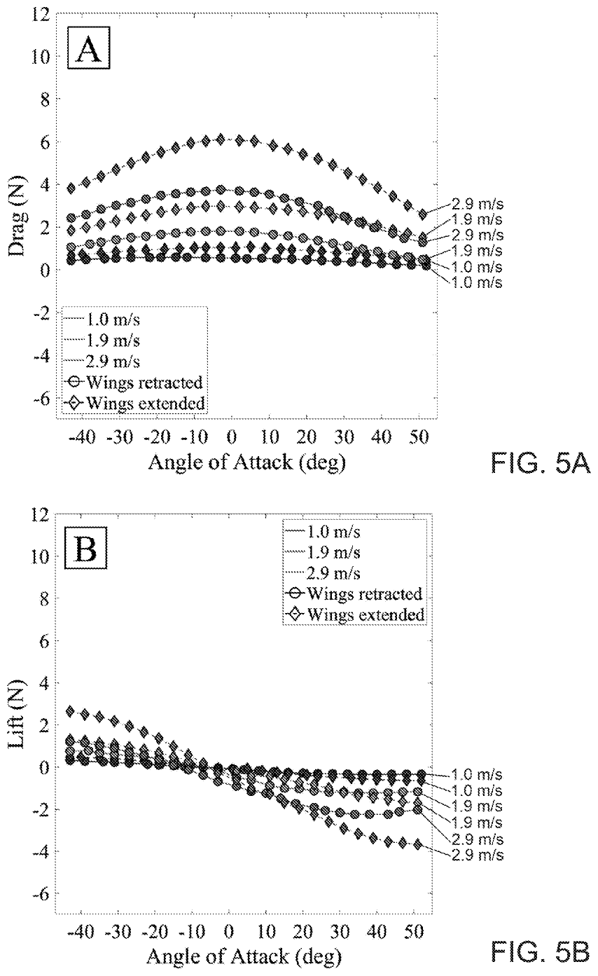

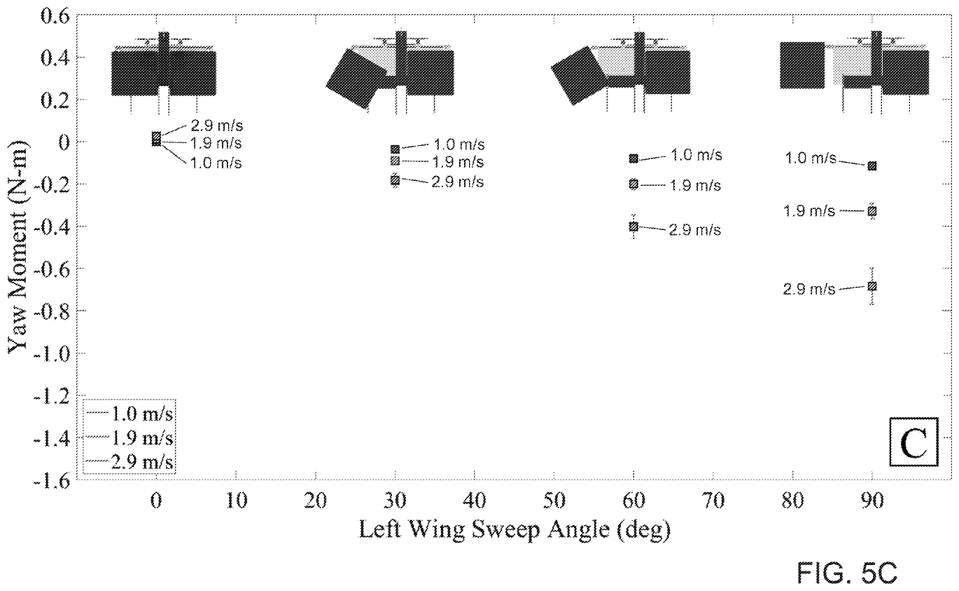

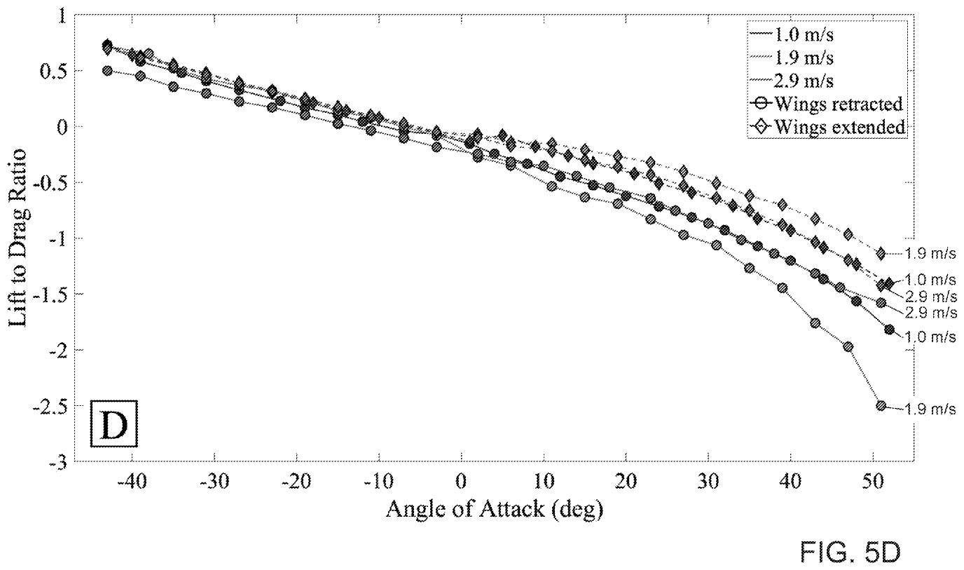

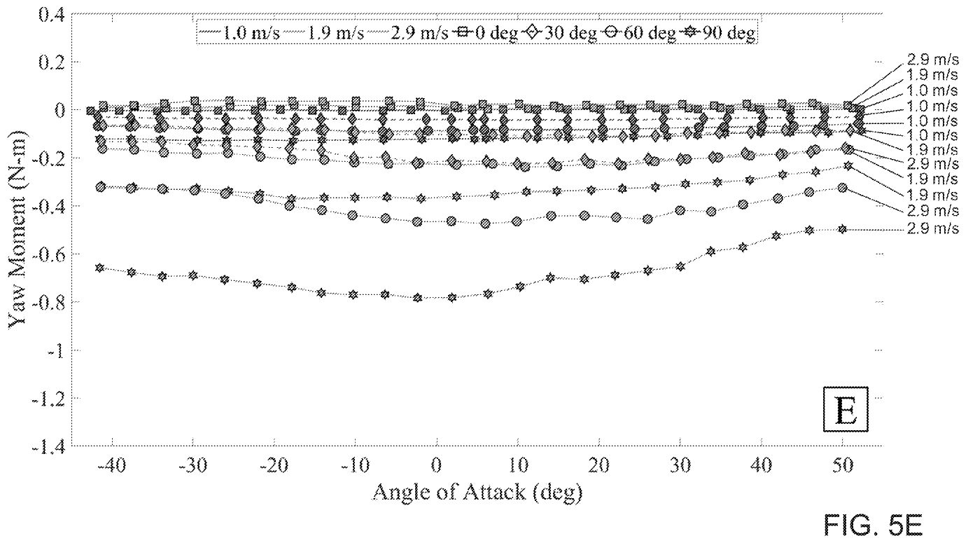

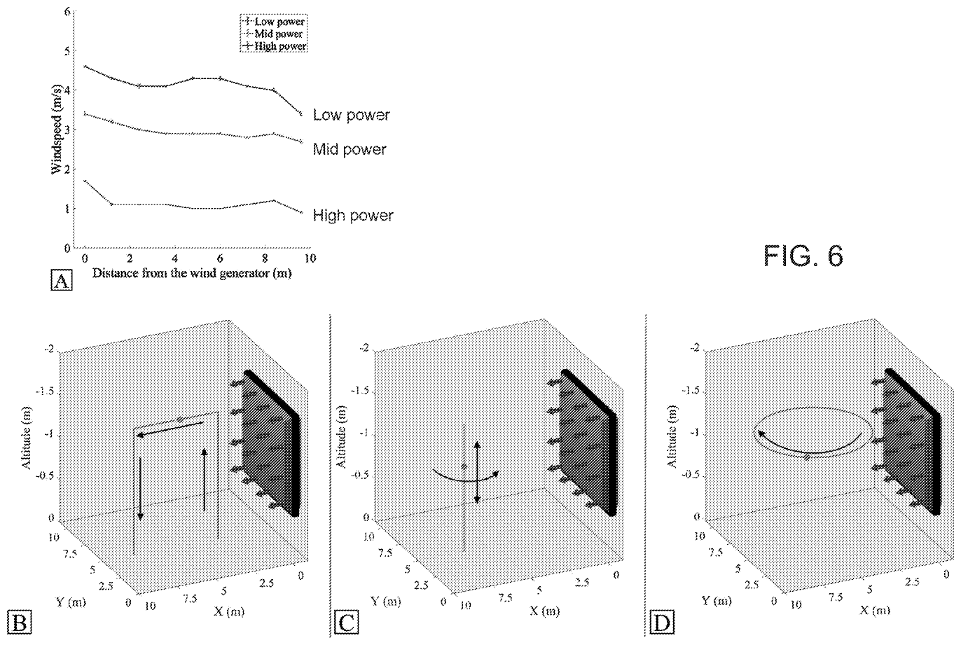

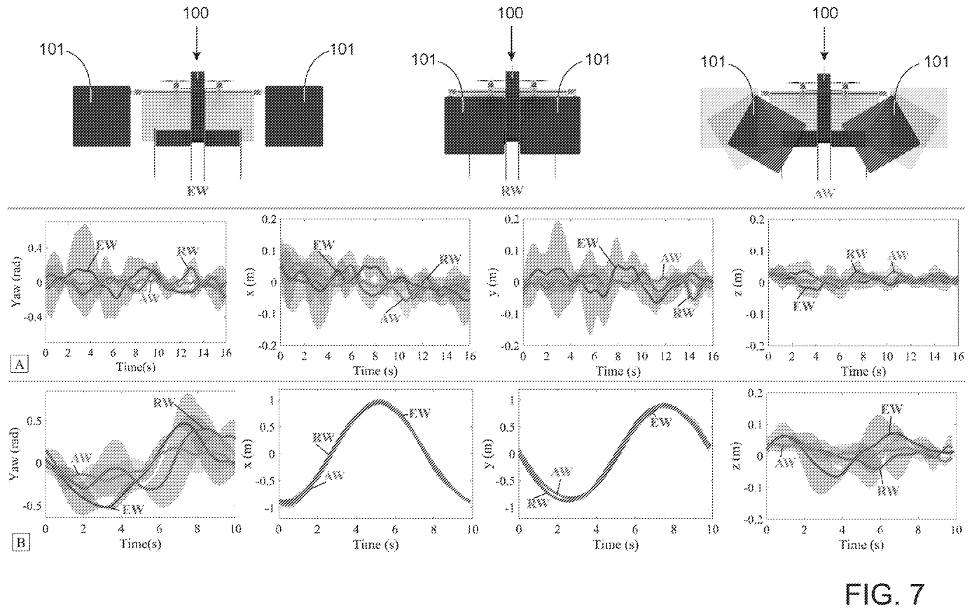

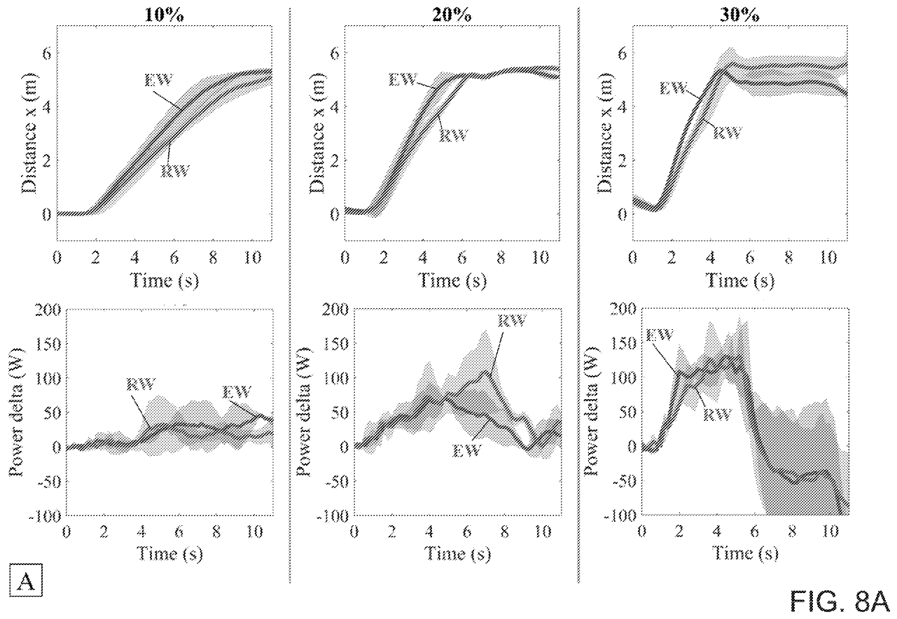

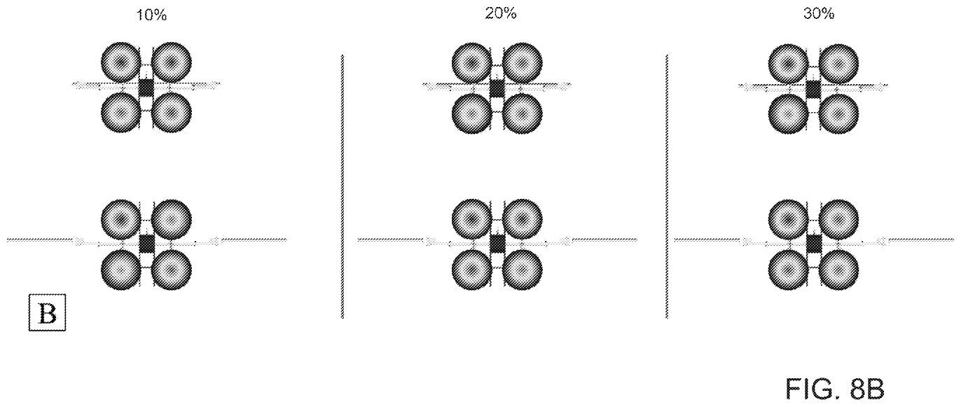

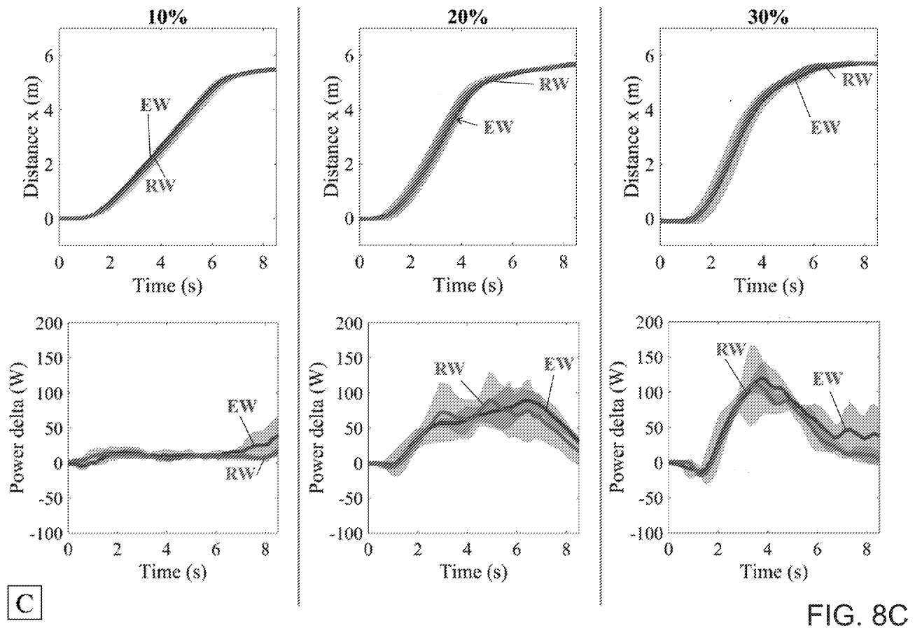

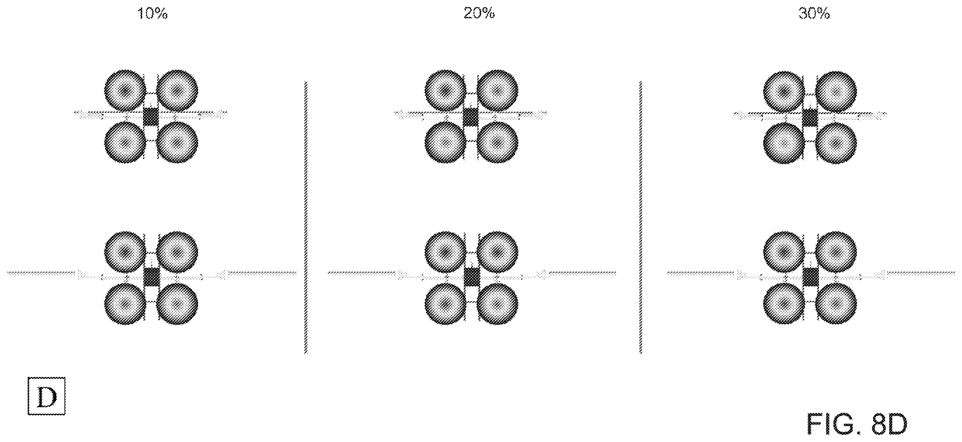

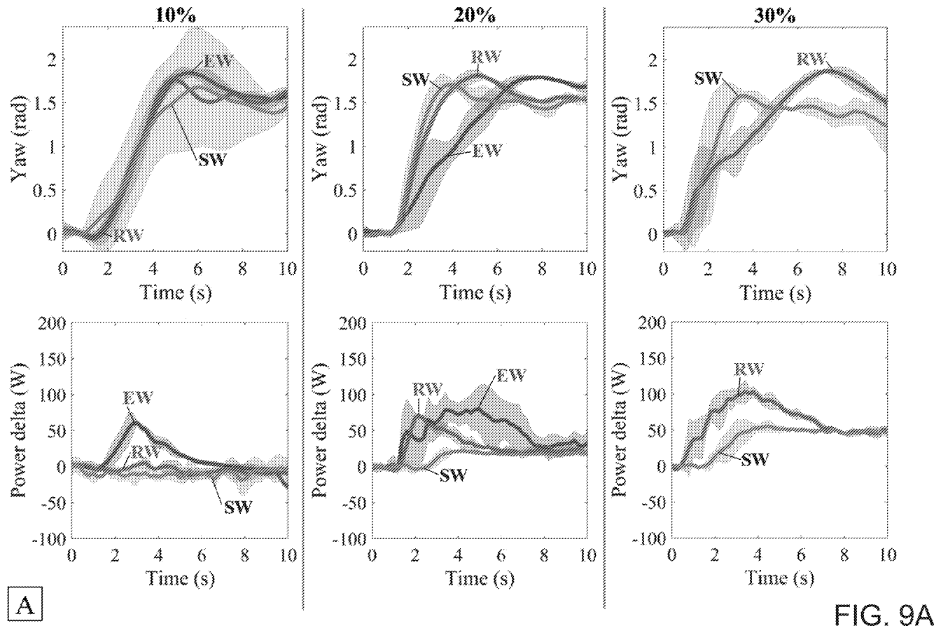

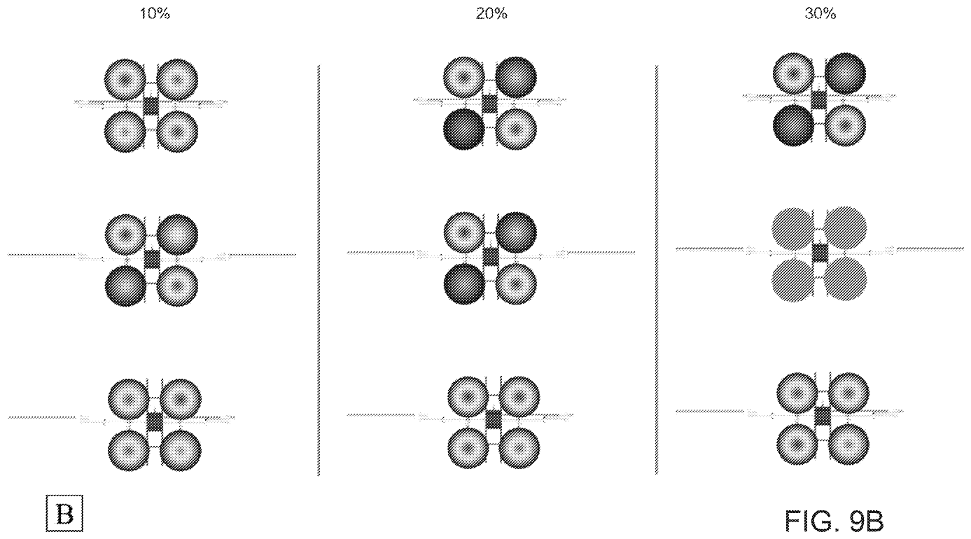

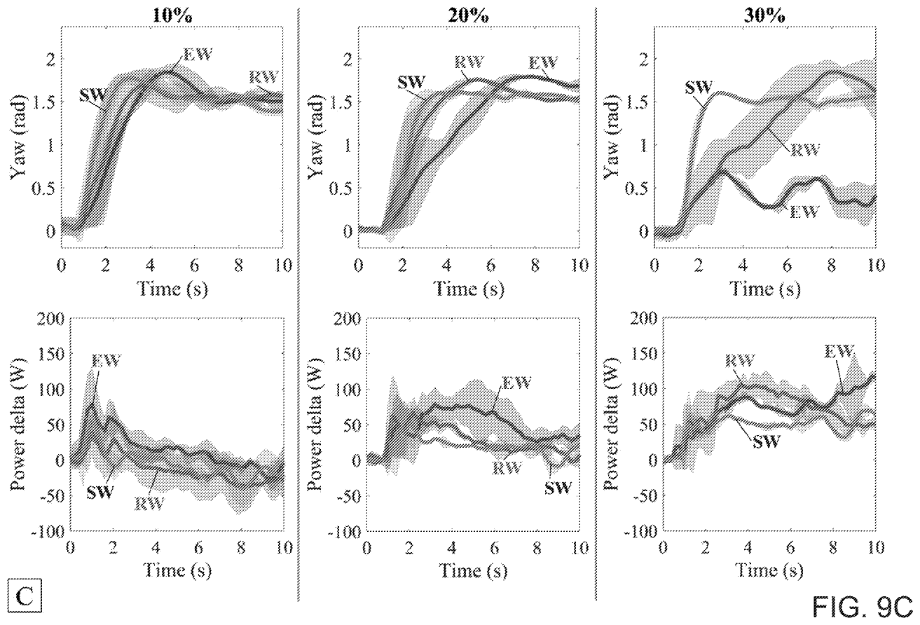

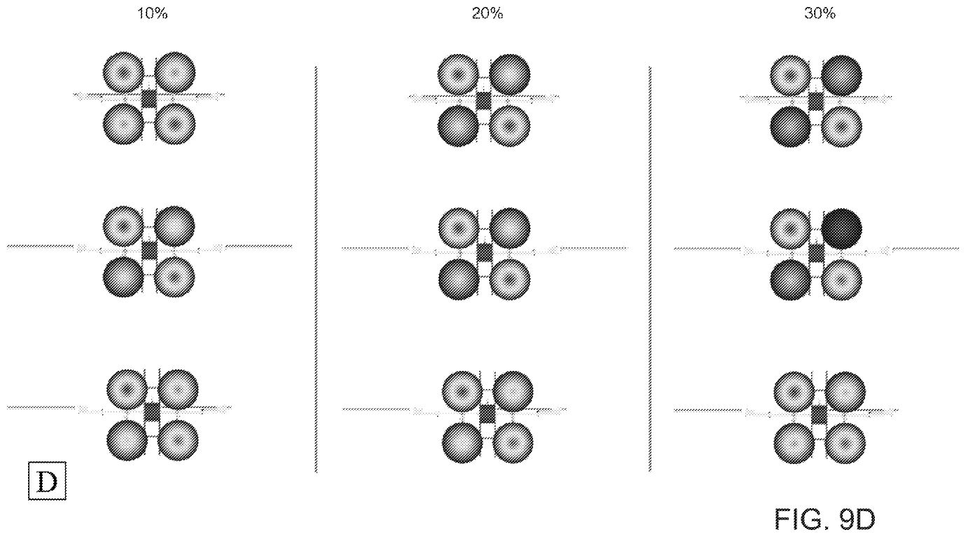

The aerodynamic results, which are displayed in FIG. 5, show an increase in lift and a decrease in drag as the plane shifts from the 0° position 5A, 5B, 5D. Drag increases significantly in the open wing configuration compared to the fully retracted wing configuration (FIG. 5A). The aerodynamic effects in both lift and drag intensify with the increase in wind speed. Yaw moments display a significant increase in the case of asymmetric morphing configurations of one wing fully extended and one wing fully retracted at all angles, as in shown in succession in FIG. 5C. The yaw moment varies from 0 Nm in the retracted wing configuration to approximately −0.8 Nm in the one wing retracted and one wing extended configuration. From FIG. 5C, a linear relationship can be identified between the wing angle and the yaw moment. In addition, an almost linear relationship is also observed between the angle of attack and the yaw moment (FIG. 5E). The linearity suggests that an error rate P controller can be sufficient for active wing yaw stabilization.

The proposed hypothesis's validation and the proposed controller's functionality require flight experiments. The experiments aimed to clarify the benefits of changing symmetrically or asymmetrically the wing area while performing different flight trajectories. Flight experiments were performed in an experimental facility composed of a motion capture system of 23 cameras and a wind stream generator capable of producing different wind velocities. The generic trajectory of a drone mission in a horizontal plane while maintaining altitude can be decomposed into three main trajectories, namely, linear trajectory, rotational trajectory, and mixed trajectory composed of both previous trajectories.

FIG. 6 illustrates, in the experimental setup disclosed above, the wind direction is known and the state estimation of the drone is provided by a motion capture system. The wind is generated by the Windshape 200 and varies by the distance.

FIG. 6(A) illustrates a diagram of wind speed to distance from the wind generator, FIG. 6(B) a linear trajectory, FIG. 6(C) a rotational trajectory and FIG. 6(D) a circular trajectory.

FIG. 7 illustrates flight experiments with active wing morphing for yaw stabilization and wind disturbance rejection. EW stands for extended wings, RW stands for retracted wings and AW stands for wings that are continuously activated between a retracted position and an extended position.

FIG. 7(A) illustrates hovering at a setpoint with a fixed orientation, and FIG. 7(B) illustrates hovering in circular trajectory (such as in FIG. 6(D).

As a first step towards performing a mixed trajectory, hovering at a setpoint was commanded. The wings 101 were continuously actuated based on the yaw rate error estimated from the autopilot. The wings activation was regulated by a custom P controller. Hovering at the setpoint with a fixed orientation parallel to the wind tunnel while exposed in a wind current, the drone 100 with active wing stabilization exceeded the performance in yaw stabilization of both fully extended and fully retracted wings 101. In fact, the standard deviation of the yaw error decreased by 76% and 69% respectively (see FIG. 7(A)). In addition, the position error in X remained the same while in the Y and Z axis it was decreased for the active wing morphing by 72% and 11% compared to the extended configuration. When compared to the retracted configuration, an increase of 14% in the position error is observed for X, while a significant improvement is displayed in Y and Z with a decrease of 48% and 26% respectively (see FIG. 7(A)).

Continuing, testing the circular trajectory (see FIG. 6(D)), where the drone 100 performs a mix of linear and rotational trajectories, revealed similar results to the hovering at a setpoint experiment. The goal was to track the trajectory; the morphing wings were used for active stabilization and wind rejection. When tracking the trajectory with active wings 101, the standard deviation of the yaw error decreased by 58% and 49% compared to fully extended wings and fully retracted wings respectively. Therefore, the drone 100 with active wing 101 morphing displayed a performance increase in yaw stabilization and the ability to better resist wind currents compared to both the extended and retracted wing configurations (see FIG. 7(B)). Although beneficial for increased stability and wind rejection, continuously morphing the wings 101 might reduce the energy performance of the vehicle. Thus, in addition to the previous experiments, we investigated the impact of morphing to a fixed symmetric or asymmetric wing configuration in such a way that we use only the wings 101 to change the drone's attitude or assist the motor's function. Linear and rotational trajectories were investigated.

FIG. 8 illustrates the drifting in linear trajectory (FIG. 6(B)) at different wind current intensities (%) and the motor saturation levels in different wind speeds while at the extended or retracted configuration. The colored circles (FIGS. 8B and 8D) represent the motor PWM (pulse width modulation) signal and thus the motor saturation. Higher change in color means higher motor saturation. EW stands for extended wings and RW stands for retracted wings. The drone 100 maneuvers without and with the motors contribution.

FIG. 8A: the drone 100 maneuvers without the motor contribution.

FIG. 8B: saturation levels for maneuvering without the motors contribution.

FIG. 8C: the drone 100 maneuvers with the motors contribution.

FIG. 8D: saturation levels for drone maneuvering with the motors contribution.

FIG. 9 illustrates the yaw in rotational trajectory (see FIG. 6(C)) at different wind current intensities (%) and the motor saturation levels in different wind speeds while at the wings extended, wings retracted or single wing extended configuration. The colored circles (FIGS. 9B and 9D) represent the motor PWM signal and thus the motor saturation, higher change in color means higher motor saturation. EW is for extended wings, RW stands for retracted wings and SW stands for a single wing extended.

FIG. 9A: the drone 100 maneuvers without the motor contribution.

FIG. 9B: saturation levels for maneuvering without the motors contribution.

FIG. 9C: the drone 100 maneuvers with the motors contribution.

FIG. 9D: saturation levels for drone maneuvering with the motors contribution. For visualization purposes we plot yaw from 0 to 2 rad.

At first, a linear trajectory was performed (as in FIG. 6(B)). The drone 100 was commanded to take off, hover, and then fly, fending off the wind generator and to a given setpoint where it was commanded to land. A custom attitude controller allowed the drone 100 to drift, while maintaining zero pitch, in the presence of wind current along the x-axis of the wind generator (FIG. 6(A)). The goal of the linear trajectory was to assess the operation and performance of the drone 100 while flying with different wing configurations in the generated wind stream. The drone 100 was placed 2.5 m from the wind generator 200 and was commanded to a setpoint 7.5 m away inside the wind stream. In this experiment, where there is no motor contribution to the horizontal displacement, it was observed that drifting with extended wings 101 is faster than drifting with retracted wings 101 due to the increased drag generated by the larger area of the extended wings (FIG. 8A). Moreover, the drone 100 is able to travel faster while maintaining the same motor thrust. This means the aircraft 100 is more controllable because it could use the motors to perform other attitude commands (FIG. 8B). In addition, extended wings 101 can reduce the drone's 100 normalized energy consumption by 4%, 28% and 2% for wind currents corresponding to 10%, 20% and 30% wind power respectively. The normalized energy consumption is calculated using the power consumption difference between the power consumed throughout the trajectory and the baseline, which is the average power required during one second in static hovering before performing the trajectory. The significant advantage is observed in middle wind current speeds where the drone 100 remains perpendicular to its z-axis. At low wind speeds, the added drag is smaller and, at high wind speeds, the drone controller tries to compensate for the generated pitching moment.

In addition to the drifting, where the motors do not actively contribute to flying throughout the commanded setpoints, experiments were performed where the drone 100 was commanded to reach a waypoint at a speed that was set to be higher than the drifting speed with the motors contributing in extended and retracted wing 101 configurations. The results are similar to the previous set of experiments. Extended wings 101 always lead to lower motor saturation levels by a few percent. On the other hand, the energy depends on the wind speed. Extended wings 101 are beneficial in the case of 20% for an 10% decrease in the normalized energy consumption. Although in the other cases, the motors consume more power to accelerate the drone 100 when at 10% or when they try to compensate for the adverse pitching moment generated at 30% wind power (FIGS. 8C,8D).

The yaw authority of the drone at different wind speeds was also tested by performing rotational trajectories. This experiment aimed to determine the effect of crosswind on the performance of the drone when commanded to achieve a specific angle using pure yaw motion in hovering flight. The drone was commanded to take off, hover, rotate to an angular setpoint, and finally land.

The drone 100 was placed 2.5 m from the wind generator 200. First, a custom attitude controller, allowed the drone 100 to rotate freely while hovering at a commanded setpoint 2.5 m from the wind generator (FIG. 6(C)). At first, the drone 100 is tested in yaw motion with one wing fully extended, thus rotating due to the yawing moment generated by the wing. To continue, the drone 100 is commanded to match the rotational speed of the one wing fully extended configuration with both wings 101 extended and both wings 101 retracted. For the one wing 101 extended configuration, it is observed a decrease in the energy consumption of up to 98% compared to the other configurations as shown in FIG. 9A. At 30% of wind current, the fully extended wings 101 cannot perform the commanded trajectory and get destabilized by the wind current. Furthermore, the motor saturation levels for the single wing 101 extended experiment remained lower when compared to the other configurations in most of the wind current speeds tests, thus enabling better maneuverability (FIG. 9B).

In addition to the yaw experiments where the motors do not actively contribute to the yaw motion, experiments were performed where the drone 100 was commanded to reach an angular waypoint at the highest possible speed with the motors contributing in all wing configurations. Though, the results are similar to the previous set of experiments. The experiments were conducted with extended wings 101, retracted wings 101, and one wing 101 extended and one retracted FIG. 9C. It is observed that when commanding the asymmetrical extension of one wing in synchronicity with the motors yaw command, the drone severely outperformed both the extended wing and the retracted wing configurations in terms of normalized energy efficiency by 75% and 77% for the extended wing configuration and by 20% and 51% respectively at wind current speed of 10% and 20%. At the same time, it is observed that at the wind current speeds of 20% and 30%, the drone 100 reaches the angular setpoint faster and with less overshoot compared to the other wing 101 configurations see FIG. 9C. The maximum yaw rate is increased up to 200%. Motor saturation levels had a similar indication to the experiments without yaw contribution due to the impact of the asymmetric wing in the yaw maneuver FIG. 9D.

The results above show that continuous morphing can assist stability and wind rejection, while morphing to a fixed configuration can help exploit wind currents to increase yaw rate or increase the normalized energy efficiency significantly. Despite performing the experiments in the Micro Aerial Vehicle scale, similar behavior is expected for larger vehicles at higher Reynolds numbers within the low Reynolds number regime of up to 150000, see reference [1]. The same aerodynamic effects are expected to be observed because of the same behavior of flat surface in the low Reynolds number regime. Meaning, that when in the deep stall, the angle of attack increases drag and decreases lift, see reference [23] For this study, the vehicle's shape was kept to the simplest possible as flat plates were used for the morphing wings and fuselage. Shape optimization can increase the aerodynamic benefits of continuous and noncontinuous morphing while sustaining larger wind currents. In addition to the previous discussion on the shape and structure, morphing wings also have the side benefit of increasing the agility and efficiency of the drone in horizontal flight see reference [24, 11].

Preferably, the drone 100 must have an accurate estimate of the wind direction and magnitude. As stated before, the wind direction is known as the drone always flies in front of the wind generator. Therefore, additional sensors or software estimators are preferably needed for a real flight mission that can be difficult to integrate into smaller vehicles. Moreover, a controller that automatically chooses between fixed or continuous wing actuation may be implemented to exploit the current method's full potential in a real flight mission. An automatic wing morphing controller would select the way of morphing depending on the mission trajectory, the effective velocity, and the wind direction change.

The present description is neither intended nor should it be construed as being representative of the full extent and scope of the present invention. The present invention is set forth in various levels of detail herein as well as in the attached drawings and in the detailed description of the invention and no limitation as to the scope of the present invention is intended by either the inclusion or non inclusion of elements, components, etc. Additional aspects of the present invention have become more readily apparent from the detailed description, particularly when taken together with the drawings.

Moreover, exemplary embodiments have been described to provide an overall understanding of the principles of the structure, function, manufacture, and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present invention is defined not solely by the claims. The features illustrated or described in connection with an exemplary embodiment may be combined with the features of other embodiments. Such modifications and variations are intended to be included within the scope of the present invention. A number of problems with conventional methods and systems are noted herein and the methods and systems disclosed herein may address one or more of these problems. By describing these problems, no admission as to their knowledge in the art is intended. A person having ordinary skill in the art will appreciate that, although certain methods and systems are described herein with respect to embodiments of the present invention, the scope of the present invention is not so limited. Moreover, while this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

### REFERENCES

[1] M. Hassanalian, A. Abdelkefi, Progress in Aerospace Sciences 2017, 99.
[2] G.J. J. Ducard, M. Allenspach, Aerospace Science and Technology 2021, 118 107035.
[3] Modelling the Flying Bird, Volume 5-1st Edition, URL https://www.elsevier.com/ books/modelling-the-flying-bird/pennycuick/978-0-12-374299-5.
[4] C. Harvey, V. B. Baliga, P. Lavoie, D. L. Altshuler, Journal of The Royal Society Interface 2019, 16, 150 20180641, publisher: Royal Society.
[5] J. A. Cheney, J. P. J. Stevenson, N. E. Durston, J. Song, J. R. Usherwood, R. J. Bomphrey, S. P. Windsor, Proceedings of the Royal Society B: Biological Sciences 2020, 287, 1937 20201748, publisher: Royal Society.
[6] D. A. Olejnik, F. T. Muijres, M. Karasek, L. Honfi Camilo, C. De Wagter, G. C. de Croon, Frontiers in Robotics and AI 2022, 9.

[7] S. Mintchev, D. Floreano, IEEE Robotics & Automation Magazine 2016, 23, 3 42.
[8] G. Heredia, A. Duran, A. Ollero, Journal of Intelligent & Robotic Systems 2012, 65, 1-4 115.
[9] K. Z. Y. Ang, J. Cui, T. Pang, K. Li, K. Wang, Y. Ke, B. M. Chen, In 11th IEEE International Conference on Control & Automation (ICCA). 2014 750-755, ISSN: 1948-3457.
[10] M. Di Luca, S. Mintchev, Y. Su, E. Shaw, K. Breuer, Science Robotics 2020, 5, 38 eaay8533.
[11] E. Ajanic, M. Feroskhan, S. Mintchev, F. Noca, D. Floreano, Science Robotics 2020, 5, 47, publisher: Science Robotics Section: Research Article.
[12] E. Chang, L. Y. Matloff, A. K. Stowers, D. Lentink, Science Robotics 2020, 5, 38 eaay1246.
[13] C. B. Jabeur, H. Seddik, International Review of Applied Sciences and Engineering 2021, −1, aop, publisher: Akadémiai Kiadó Section: International Review of Applied Sciences and Engineering.
[14] J. F. Whidborne, A. K. Cooke, IFAC-PapersOnLine 2017, 50, 2 175.
[15] Y. Yang, J. Zhu, X. Zhang, X. Wang, In 2018 IEEE/RSJ International Conference on Intelligent Robots and Systems (IROS). 2018 6390-6396, ISSN: 2153-0866.
[16] C. Montella, J. R. Spletzer, In 2014 IEEE/RSJ International Conference on Intelligent Robots and Systems. 2014 3423-3428, ISSN: 2153-0866.
[17] V. Bonnin, E. Benard, J.-M. Moschetta, C. A. Toomer, International Journal of Micro Air Vehicles 2015, 7, 3 213, publisher: SAGE Publications Ltd STM.
[18] I. Mir, A. Maqsood, S. A. Eisa, H. Taha, S. Akhtar, Aerospace Science and Technology 2018, 79 17.
[19] Y. Zhao, A. Dutta, P. Tsiotras, M. Costello, Journal of Guidance, Control, and Dy-namics 2018, 41, 2 488, publisher: American Institute of Aeronautics and Astronautics eprint: https://doi.org/10.2514/1.G003048.
[20] WindShape-Drone Test Equipment and Services—Wind Tunnel, URL https://www.windshape.ch/.
[21] C. Vourtsis, V. Casas Rochel, F. Ramirez Serrano, W. Stewart, D. Floreano, IEEE Robotics and Automation Letters 2021, 1-1, conference Name: IEEE Robotics and Automation Letters.
[22] C. Vourtsis, W. Stewart, D. Floreano, IEEE Robotics and Automation Letters 2022, 7, 1 223, conference Name: IEEE Robotics and Automation Letters.
[23] M. Shademan, A. Naghib-Lahouti, Advances in Aerodynamics 2020, 2, 1 14.
[24] M. Di Luca, S. Mintchev, G. Heitz, F. Noca, D. Floreano, Interface Focus 2017, 7, 1 20160092.

1. A method of manoeuvring a vertical take-off and landing, unmanned aerial drone comprising at least an aerodynamic surface, wherein, during a flight of the drone, the aerodynamic surface generates lift and/or drag and an aerodynamic surface area is dynamically varied to compensate for adverse wind currents and/or to use said wind currents and/or to use an effective airspeed velocity as an assistance in manoeuvring the drone flight, said aerodynamic surface area variations allowing to reduce an energy consumption of the drone.

2. The method according to claim 1, wherein said aerodynamic surface area variations are carried out during hovering of the drone.

3. The method according to claim 1, wherein the aerodynamic surface area is varied dynamically, continuously, symmetrically or asymmetrically between a minimum and maximum surface area configuration.

4. The method according to claim 1, wherein the aerodynamic surface area is varied asymmetrically by adapting one of said at least an aerodynamic surface area between a minimum and a maximum surface area configuration.

5. The method according to claim 4, wherein the asymmetrical surface area variations allow an attitude control of the drone and/or to increase the maximum achievable yaw rate.

6. The method according to claim 1, wherein the aerodynamic surface is provided at least by wings of the drone.

7. The method as defined in claim 6, wherein the aerodynamic surface area variation is realized at least by a displacement of at least one of said wings.

8. The method according to claim 7, wherein the aerodynamic surface area is varied by a rotation of said wings between a retracted position close to the drone and an extended position away from the drone.

9. The method according to one claim 1, wherein the aerodynamic surface area is varied dynamically and/or statically and/or continuously by an active or passive mechanism.

10. The method as defined in claim 1, wherein the aerodynamic surfaces are continuous or non-continuous.

11. The method as defined in claim 1, wherein the aerodynamic surface area is varied in a linear way and/or a non-linear way.

12. The method as defined in claim 1, wherein said method is adapted to different hovering speeds by changing the design or shape of the wings or fuselage of the drone, or by changing the morphing rate.

13. A vertical take-off and landing, unmanned aerial drone using the method as defined in claim 1.
